(19) United States
(12) Patent Application Publication
(10) Pub. No.: US 2007/0127071 A1
(43) Pub. Date: Jun. 7, 2007

(54) Image forming method and image processing apparatus

(75) Inventors: Yang-o Kim, Seoul (KR); Young-kak Lim, Gunpo-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/633,439

(22) Filed: Dec. 5, 2006

(30) Foreign Application Priority Data
Dec. 7, 2005 (KR) 10-2005-0118587

(51) Int. Cl. G06K 15/00

(52) U.S. Cl. 358/1.16; 358/1.17

(57) ABSTRACT

An image forming method and apparatus for forming an image on opposite sides of a printing paper which includes operations for receiving a plurality of pages of printing data, processing the printing data to generate first side data in which the printing data is printed in a page order, and second side data in which the printing data of set or selected pages from among the printing data is printed, and printing the first side data on a first side of the printing paper and the second side data on a second side of the printing paper such that a page can be viewed, and previous and/or following pages can be simultaneously viewed on an adjacent page.

### CROSS-REFERENCE TO RELATED APPLICATIONS

This application claims the benefit under 35 U.S.C. §119(a) of Korean Patent Application No. 10-2005-0118587, filed in the Korean Intellectual Property Office on Dec. 7, 2005, the entire disclosure of which is incorporated herein by reference.

### BACKGROUND OF INVENTION

1. Field of Invention:

The present invention relates to an image forming apparatus. More particularly, the present invention relates to an image forming apparatus for providing improved readability of successive pages.

2. Description of the Related Art:

Generally, an image forming apparatus prints image information processed by an image processing apparatus such as a host computer on a printing paper. The typical image forming apparatus can be classified as an electrophotographic type performing development by spreading developer on an electrostatic latent image formed on a photosensitive body by a potential difference and transferring it on a printing paper to form an image, an inkjet type forming an image by jetting ink on a printing paper through a plurality of ink nozzles, a thermal transfer type forming an image by adhering an ink ribbon to a printing paper and selectively heating the ink ribbon to transfer ink of the ink ribbon on the printing paper, and so forth.

In general, when a reader reads a plurality of pages of printing data, contents of different adjacent pages must often be referred to so that the contents of the present page can be more accurately understood. Also, in the case where a certain subject is printed sequentially over a plurality of pages, the reader is often required to read, alternately, different pages adjacent to the present page to understand the subject. Accordingly, as the reader must often turn the pages back and forth, a reading of the successive pages is interrupted and as a result, the comprehension of the contents may become depreciated. Particularly, in a case where the printed matter is bookbound and the page position of the printed matter is fixed, such a problem may become even more of an interruption to the subject comprehension of the reader.

Accordingly, a need exists for a system and method for improving the readability of successive pages.

### SUMMARY OF THE INVENTION

It is therefore an object of embodiments of the present invention to substantially solve the above and other problems, and provide an image forming method and an image forming apparatus providing an improved readability of successive pages.

Additional aspects of embodiments of the present invention will be set forth in part in the description which follows and, in part, will be obvious from the description, or may be learned by the practice of the present invention.

The foregoing and/or other aspects of embodiments of the present invention can be achieved by providing an image forming method for forming an image on opposite sides of a printing paper, comprising receiving a plurality of pages of printing data, processing the printing data to generate first side data in which the printing data is printed in a sequential page numbered order and second side data in which the printing data of set or selected pages from among the printing data is printed, and printing the first side data on a first side of the printing paper and the second side data on a second side of the printing paper.

According to an aspect of embodiments of the present invention, the second side data can be generated in which the printing data of the selected pages among the printed data is configured to be printed in a sequential page order on the second side.

According to another aspect of embodiments of the present invention, the second side data can be generated so that the printing data of the pages before and after the following page of the page printed on the first side of the printing paper is configured to be printed on the second side.

According to another aspect of embodiments of the present invention, the image forming method further comprises generating the second side data so that the printing data of the pages before and after the previous page of the page printed on the first side of the printing paper is configured to be printed on the second side.

According to another aspect of embodiments of the present invention, the image forming method further comprises setting or selecting pages to be printed on the second side of the printing paper, wherein the data processing stage generates the second side data according to the selected pages.

According to another aspect of embodiments of the present invention, the page setting stage comprises setting or selecting page numbers to be printed on the second side of the printing paper.

According to another aspect of embodiments of the present invention, the page setting stage comprises setting or selecting page numbers to be printed on the second side of the printing paper using at least one of an application program, an operating panel of the image forming apparatus or an external device for selective input of pages to be printed.

The foregoing and/or other aspects of embodiments of the present invention can also be achieved by providing an image forming apparatus comprising an image forming part capable of printing on opposite sides of a printing paper, a data receiving part for receiving a plurality of pages of printing data, a data processing part for processing the printing data to generate first side data in which the printing data is printed in a sequential page numbered order and second side data in which the printing data of set or selected pages from among the printing data is printed, and a controller for enabling the image forming part to print the first side data on a first side of the printing paper and the second side data on a second side of the printing paper.

According to an aspect of embodiments of the present invention, the second side data can be generated in which the printing data of the set or selected pages among the printing data is configured to be printed in a sequential page order on the second side.

According to another aspect of embodiments of the present invention, the second side. data can be generated so that the printing data of the pages before and after the following page of the page printed on the first side of the printing paper is configured to be printed on the second side.

According to another aspect of embodiments of the present invention, the data processing part is configured to generate the second side data so that the printing data of the pages before and after the previous page of the page printed on the first side of the printing paper is configured to be printed on the second side.

According to another aspect of embodiments of the present invention, the image forming apparatus further comprises a user interface part for allowing the selective input of pages by a user, wherein the data processing part generates the second side data so that a specific page is printed on the basis of the selective input received through the user interface part.

According to another aspect of embodiments of the present invention, the user interface part comprises a page number selecting part for selectively inputting page numbers to be printed on the second side of a printing paper.

According to another aspect of embodiments of the present invention, the user interface part is provided as at least one of an operating panel or an external device for allowing the user to selectively input page numbers to be printed on the second side of a printing paper.

The foregoing and/or other aspects of embodiments of the present invention can also be achieved by providing a computer-readable medium storing a computer program for executing an image forming method in an image forming apparatus, comprising a first set of instructions for receiving a plurality of pages of printing data, a second set of instructions for processing the printing data to generate first side data in which the printing data is printed in a sequential page numbered order, and second side data in which the printing data of selected pages among the printing data is printed, and a third set of instructions for controlling the image forming device to print the first side data on a first side of a printing paper and the second side data on a second side of the printing paper.

It is to be understood that both the foregoing general description and the following detailed description are exemplary and explanatory, and are intended to provide further explanation of the invention as claimed.

### BRIEF DESCRIPTION OF THE DRAWINGS

The above and/or other aspects and advantages of embodiments of the prevent invention will become apparent and more readily appreciated from the following description of the exemplary embodiments, taken in conjunction with the accompany drawings, in which:

FIG. 1 is a block diagram illustrating an image forming apparatus according to a first exemplary embodiment of the present invention;

FIG. 2 is a flow diagram illustrating an image forming method of the image forming apparatus in FIG. 1;

FIG. 3 is a schematic view illustrating a printing result of the image forming apparatus in FIG. 1;

FIG. 4 is a schematic view illustrating a printing result of an image forming apparatus according to a second exemplary embodiment of the present invention; and

FIG. 5 is a block diagram illustrating an image forming apparatus according to a third exemplary embodiment of the present invention.

Throughout the drawings, like reference numerals will be understood to refer to like parts, components and structures.

### DETAILED DESCRIPTION OF EXEMPLARY EMBODIMENTS

Reference will now be made in detail to embodiments of the present invention, examples of which are illustrated in the accompanying drawings, wherein like reference numerals refer to like elements throughout. The embodiments are described below so as to explain the present invention by referring to the figures.

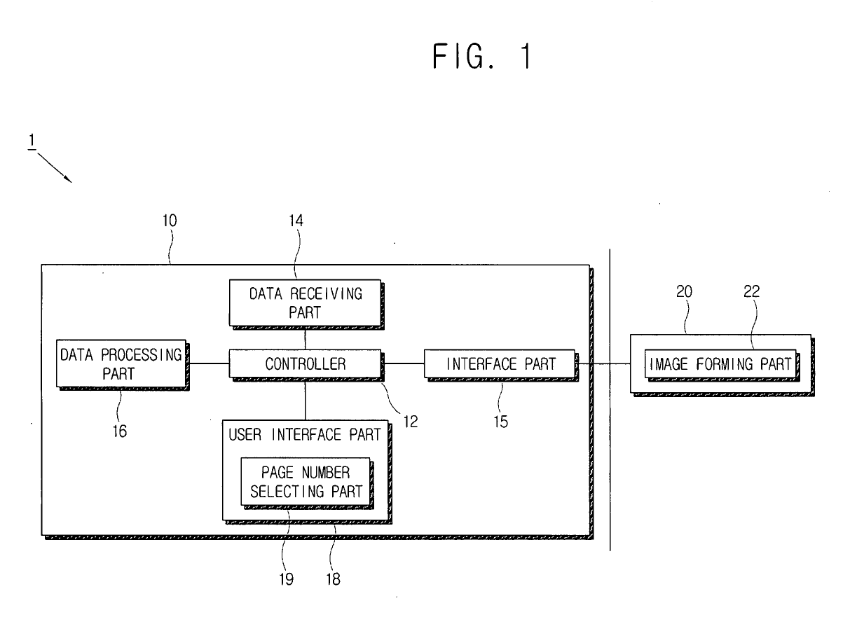

As shown in FIG. 1, an image forming apparatus 1 according to a first exemplary embodiment of the present invention comprises an image forming device 20 having an image forming part .22, and a host 10 communicatively connected to the image forming device 20. The image forming part 22 can selectively form an image on opposite sides of a printing paper in an automatic method or a manual method. The image forming part 22 can comprise a developing device of a laser printer, an inkjet head of an inkjet printer, a thermal transfer head of a thermal transfer printer, or the like. The host 10 can be provided as a personal computer, a laptop computer, and so forth.

The host 10 comprises an interface part 15, a data receiving part 14, a data processing part 16, a user interface part 18, and a controller 12 for controlling the elements of the host 10. The interface part 15 connects the host 10 and the image forming device 20 to provide communications between each. The interface part 15 can be provided to perform wired or wireless communications, such as through cable or radio communication methods. The data receiving part 14 can receive one or more pages of printing data, but for purposes of illustration in the following description, the receiving part 14 receives a plurality of pages of printing data having page arrangement orders (that is, for example, sequential page numbering for ordered printing). The data receiving part 14 can be provided as a memory part for storing the printing data, a receiving part for receiving information from a network, or a unit for reading information from an external memory such as a USB memory, but is not limited thereto.

The data processing part 16 processes printing data to generate first side data in which the printing data received by the data receiving part 14 is printed according to the page order, and second side data printed according to preset or selected pages from among the printing data. The first side data is generated to be printed in order on the printing paper in the order of the original pages (that is, pages 1, 2, 3, and so forth, but not limited thereto). The first side data can include the original data of the printing data. In this case, the data processing part 16 can process the printing data as the first side data without generating the first page data separately. The second side data is generated to print a plurality of pages of printing data adjacent to the first side data printed on the first side of the printing paper.

The data processing part 16 generates the second side data so that the printing data of pages before and after the following page of the page printed on the first side of the printing paper can be printed. The controller 12 controls the image forming part 22 to print the first side data on the first side of the printing paper and the second page data on the second side of the printing paper. Accordingly, a user can easily read the contents of the page printed on the first side while referring to the contents of the pages printed on the second side of the printing paper.

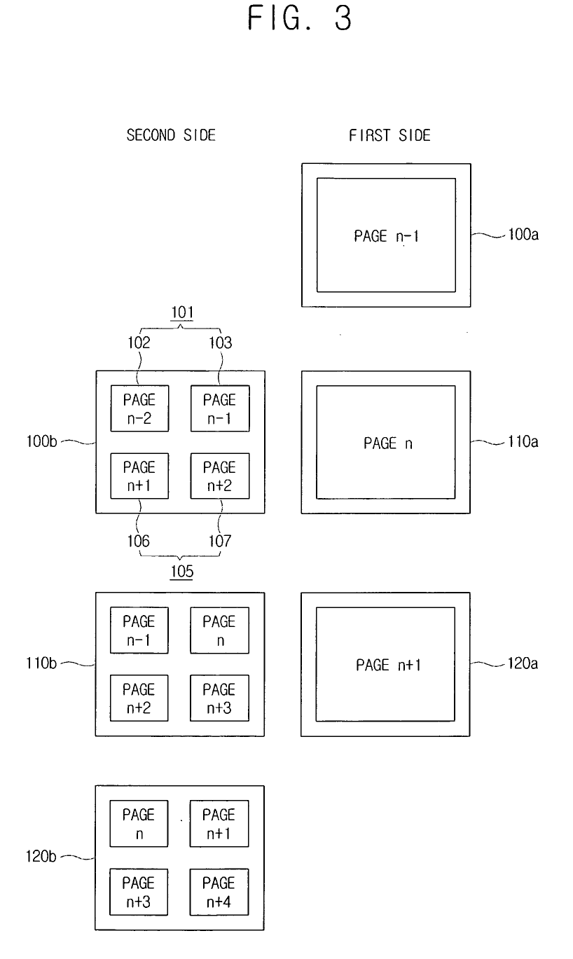

For example, in the case where four pages are printed on the second page of the printing paper (referred to as 4-up printing), printing data of a page n is printed on the first side of the M^{th} printing paper (see 110a of FIG. 3), and the page n and a page n−1 before a page n+1 following the page n, and a page n+2, and a page n+3 after the page n, are all printed on the second side of the M^{th} printing paper (see 110b of FIG. 3). On the first side of the M+1^{st} printing paper is printed the printing data of the page n+1. Accordingly, when the printing data is bookbound and a user turns the M^{th} printing paper, the user can then read the contents of the page n+1 printed on the first side of the M+1^{st} printing paper and the contents of the pages n−1, n, n+2 and n+3 printed on the second side of the M^{th} printing paper at the same time.

In accordance with another embodiment of the present invention, in the case where two pages are printed on the second side of the printing paper (referred to as 2-up printing), on the first side of the M+1^{st} printing paper can be printed the printing data of the page n+1, and on the second side of the M^{th} printing paper can be printed the printing data of the pages n and n+2. Alternately, on the second side of the printing paper can be printed the printing data of the N page (referred to as N-up printing).

In accordance with still another embodiment of the present invention, the second side data may be generated so that a plurality of pages before or after the following page of the page printed on the first side of the printing paper can be printed. That is, in the case where four pages are printed on the second side of the printing paper, on the first page of the M^{th} printing paper can be printed the printing data of the page n, and on the second side of the M^{th} printing paper can be printed the printing data of the pages n, n−1, n−2 and n−3 occurring before the page n+1 following the page n, or the printing data of the pages n+2, n+3, n+4and n+5 occurring after the page n+1. Alternatively, the second side data can be set to selectively print a singular page instead of a plurality of pages.

The user interface part 18 can be provided with an inputting part (not shown) for allowing the selective input of pages by a user and a display part (not shown) for displaying information to be recognized by a user. The data processing part 16 can generate the second side data on the basis of a user's selective input through the user interface part 18.

The user interface part 18 is provided with a page number selecting part 19 for selectively inputting page numbers to be printed on the second page of the printing paper. A user can determine the page numbers to be printed on the second side through the page number selecting part 19. For example, when a user selectively inputs four pages through the page number selecting part 19, the data processing part 16 generates the second side data so that four pages can be printed on one page of the printing paper. The user interface part 18 can be provided with a successive direction selecting part (not shown) for selecting whether the plurality of pages printed on the second side are those before and after the following page (divided equally or in some other ratio), or are those before or after the following page. The user interface part 18 can be provided as a printer driver or a part of an application, but is not limited thereto.

Alternatively, the user interface part 18 can be omitted as necessary, since the controller 12 can also enable the data processing part 16 to generate the second page data on the basis of a predetermined program instead of being based on the selective input through the user interface part 18 as described above.

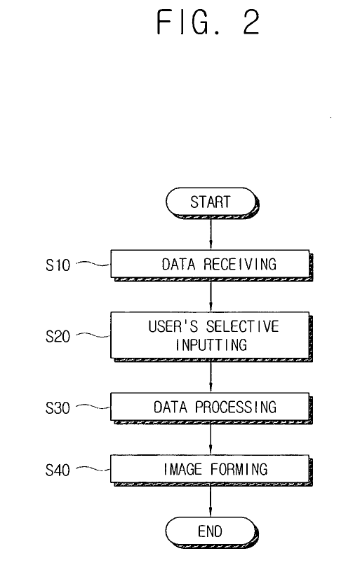

Hereinafter, an image forming method according to the first embodiment of the present invention will be described by referring to FIGS. 1 and 2.

As shown in FIGS. 1 and 2, a plurality of pages of printing data having page arrangement orders are received at step (S10), and a user can selectively input characteristics of the second side data at step (S20). Here, the user can select page numbers to be printed on the second page of the printing paper (N-up printing selection). The user can selectively input the characteristics of the second side data through an operating panel (not shown) provided for the image forming device 20 or through the interface part 18 of the host 10.

Next, the printing data is processed so that the first side data to be printed according to the page orders and the second side data to be printed according to preset pages among printing data on the basis of the user's selective input can be generated at step (S30). Then, on the first side of the printing paper is printed the first side data and on the second page of the printing paper is printed the second side data at step (S40). Here, the selective input by the user at step (S20) can be omitted as necessary, and the second side data can be set to be generated on the basis of a predetermined program. In accordance with another embodiment of the present invention, the second side data can be set to print a singular page instead of a plurality of pages.

Hereinafter, a printing result of the image forming apparatus according to the first embodiment of the present invention will be described by describing 4-up up printing as an example.

FIG. 3 is a schematic view illustrating a printing result of the image forming apparatus in FIG. 1. As shown, a plurality of pages of printing data having page orders such as pages n−1, n, and n+1 are printed on the M−1^{st} printing paper, the M^{th} printing paper, and the M+1^{st} printing paper, respectively, by the image forming apparatus 1. On a first side 100a and a second side 100b of the M−1^{st} printing paper are printed the first side data and the second side data, respectively. The M^{th} printing paper (110a and 110b) and the M+1^{st} printing paper (120a and 120b) are also printed on opposite sides of the printing papers. Accordingly, the first sides 100a, 110a and 120a of the printing papers are located on the right side and the second sides 100b, 110b and 120b of the printing papers are located on the left side, for example, as when viewing an open book.

On the first sides 100a, 110a and 120a of the printing papers are printed the printing data in the sequential page numbered order. On the first side 100a of the M−1^{st} printing paper is printed the printing data of the page n−1, and on the first side 110a of the M^{th} printing paper is printed the printing data of the page n, and so forth.

On the second sides 100b, 110b and 120b of the printing papers are printed pages before and after the following page of the first side pages 100a, 110a and 120a. On the second side 100b of the M−1^{st} printing paper is printed the pages 101 including pages n−2 (102) and n−1 (103) occurring before the page n following the first side page 100a, and pages 105 including the pages n+1 (106) and n+2 (107) occurring after the page n. That is, the two previous and two following pages are shown opposite to the current page.

Accordingly, the page n is printed on the first side 110a of the M^{th} printing paper located on the right side, and the pages n−2 (102), n−1 (103), n+1 (106) and n+2 (107) are printed on the second side 100b of the M−1^{st} printing paper located on the left side. Accordingly, a user can at once identify the contents of the page n and the contents of the four pages before and/or after the page n.

Hereinafter, an image forming apparatus according to a second exemplary embodiment of the present invention will be described by referring to FIGS. 1, 2 and 4.

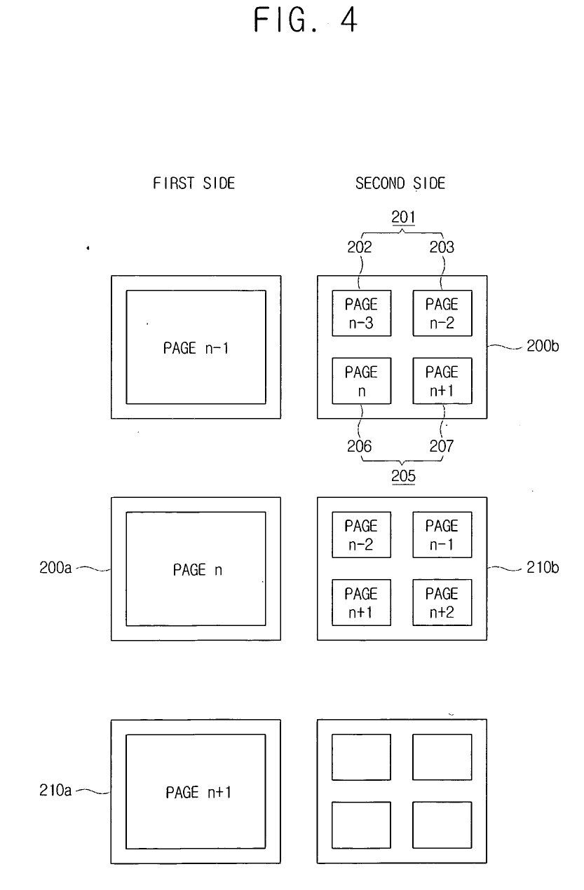

FIG. 4 is a schematic view illustrating a printing result of the image forming apparatus according to the second exemplary embodiment of the present invention. As shown, the data processing part 16 generates the second side data so that the printing data of the pages occurring before and after the previous page of the page printed on the first side of the printing paper can be printed.

The printing paper is located so that the first sides 200a and 210a of the printing papers can form a left side and the second sides 200b and 210b can form a right side, for example, as when viewing an open book.

On the first side 200a of the M^{th} printing paper is printed the printing data of the page n, and on the second side 200b of the M^{th} printing paper is printed the pages 201 including the pages n−(202), and n−2 (203) occurring before the previous page n−1 of the first side page 200a, and the pages 205 including the pages n (206), and n+1 (207), occurring after the previous page n−1 of the first side page 200a. Accordingly, in the case where the first side of the printing paper is located on the left side, and the second side is located on the right side, a present page and a plurality of pages occurring before and/or after the present page can be identified at once.

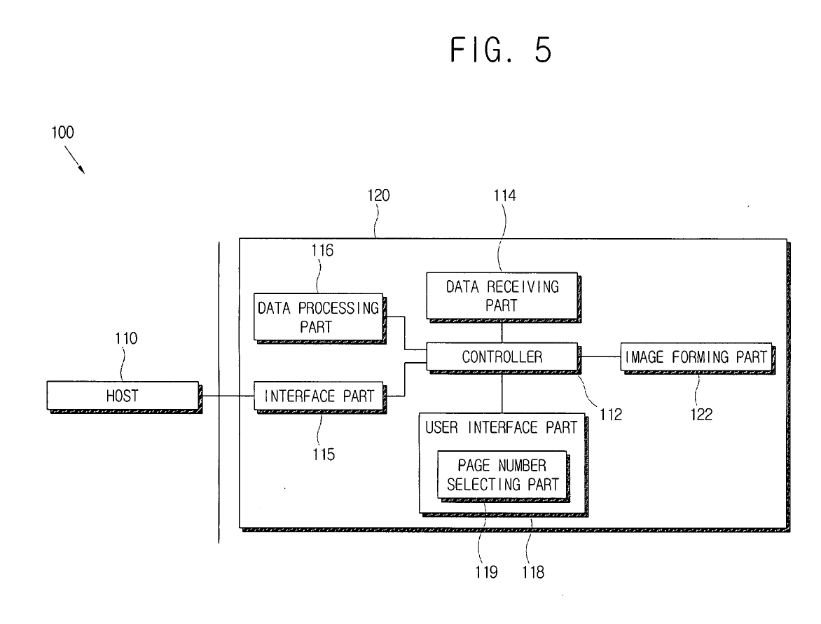

Hereinafter, an image forming apparatus according to a third exemplary embodiment of the present invention will be described by referring to FIG. 5.

As shown in FIG. 5, an image forming apparatus 100 comprises a host 110 and an image forming device 120. The image forming device 120 comprises an interface part 115, a data receiving part 114, a data processing part 116, a user interface part 118 and a controller 112. The user interface part 118 can be provided as an operating panel, and can include a page number selecting part 119. An image forming part 122 can be included and is capable of performing printing on opposite sides of a printing paper. The data receiving part 114 receives printing data, and the data processing part 116 processes the printing data to generate first side data and second side data substantially as described above. The controller 112 then controls the image forming part 122 to print the first side data on the first side of the printing paper and the second side data on the second side of the printing page.

Embodiments of the present invention can be realized in a number of ways, including computer-readable code written on computer-readable recording medium. The computer-readable recording medium can be any type of recording device in which data is stored in a computer-readable manner. Examples of the computer-readable recording medium include, but are not limited to, ROM, RAM, CD-ROM, magnetic tape, floppy disc, optical data storage, and carrier wave (e.g., data transmission through the Internet). The computer-readable recording medium can be distributed over a plurality of computer systems connected to a network so that computer-readable code is written thereto and executed therefrom in a decentralised manner. Further, functional programs, code, and code segments needed for realising embodiments of the present invention can be easily construed by one of ordinary skill in the art.

As described above, the image forming method and the image forming apparatus according to embodiments of the present invention can print a plurality of adjacent pages on different sides of a printing paper, thereby improving readability of successive pages for promoting user comprehension.

Although a number of exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An image forming method for forming an image on opposite sides of a printing paper, comprising:
receiving a plurality of pages of printing data;
processing the printing data to generate first side data in which the printing data is printed in a sequential page numbered order, and second side data in which the printing data of selected pages among the printing data is printed; and
printing the first side data on a first side of a printing paper and the second side data on a second side of the printing paper.

2. The image forming method according to claim 1, further comprising generating the second side data in which the printing data of the selected pages among the printed data is configured to be printed in a sequential page order on the second side.

3. The image forming method according to claim 2, further comprising generating the second side data so that the printing data of the pages before and after the following page of the page printed on the first side of the printing paper is configured to be printed on the second side.

4. The image forming method according to claim 2, further comprising generating the second side data so that the printing data of the pages before and after the previous page of the page printed on the first side of the printing paper is configured to be printed on the second side.

5. The image forming method according to claim 1, further comprising selecting pages to be printed on the second side of the printing paper, wherein the data processing stage generates the second side data according to the selected pages.

6. The image forming method according to claim 5, wherein the page selecting stage comprises selecting page numbers to be printed on the second side of the printing paper.

7. The image forming method according to claim 5, wherein the page selecting stage comprises selecting page numbers to be printed on the second side of the printing paper using at least one of an application program, an operating panel of the image forming apparatus, or an external device.

8. An image forming apparatus, comprising:
an image forming part for printing on opposite sides of a printing paper;
a data receiving part for receiving a plurality of pages of printing data;
a data processing part for processing the printing data to generate first side data in which the printing data is printed in a sequential page numbered order, and second side data in which the printing data of selected pages among the printing data is printed; and
a controller for controlling the image forming part to print the first side data on a first side of a printing paper and the second side data on a second side of the printing paper.

9. The image forming apparatus according to claim 8, wherein the data processing part is configured to generate the second side data in which the printing data of the selected pages among the printing data is configured to be printed in a sequential page order on the second side.

10. The image forming apparatus according to claim 9, wherein the data processing part is configured to generate the second side data so that the printing data of the pages before and after the following page of the page printed on the first side of the printing paper is configured to be printed on the second side.

11. The image forming apparatus according to claim 9, wherein the data processing part is configured to generate the second side data so that the printing data of the pages before and after the previous page of the page printed on the first side of the printing paper is configured to be printed on the second side.

12. The image forming apparatus according to claim 8, further comprising:
a user interface part for receiving a selection input from a user,
wherein the data processing part is configured to generate the second side data so that a specific page is printed on the basis of the selection input received through the user interface part.

13. The image forming apparatus according to claim 12, wherein the user interface part comprises a page number selecting part for inputting page numbers to be printed on the second side of a printing paper.

14. The image forming apparatus according to claim 12, wherein the user interface part comprises at least one of an operating panel or an external device.

15. An image forming apparatus, comprising:
a data processing part for processing printing data to generate first side data in which the printing data is printed in a sequential page numbered order, and second side data in which the printing data of selected pages among the printing data is printed; and
a controller for controlling an image forming part to print the first side data on a first side of a printing paper and the second side data on a second side of the printing paper, such that the first side data is viewed in an adjacent manner to the second side data, wherein the second side data comprises a plurality of pages.

16. The image forming apparatus according to claim 15, further comprising:
an image forming part for printing on opposite sides of a printing paper; and
a data receiving part for receiving a plurality of pages of printing data.

17. The image forming apparatus according to claim 15, wherein the second side comprises a plurality of pages adjacent to the page of the first side.

18. A computer-readable medium storing a computer program for executing an image forming method in an image forming apparatus, comprising:
a first set of instructions for receiving a plurality of pages of printing data;
a second set of instructions for processing the printing data to generate first side data in which the printing data is printed in a sequential page numbered order, and second side data in which the printing data of selected pages among the printing data is printed; and
a third set of instructions for controlling the image forming device to print the first side data on a first side of a printing paper and the second side data on a second side of the printing paper.

19. The computer-readable medium according to claim 18, further comprising a set of instructions for generating the second side data in which the printing data of the selected pages among the printed data is configured to be printed in a sequential page order on the second side.
